(19) United States
(12) Patent Application Publication
(10) Pub. No.: US 2025/0019515 A1
(43) Pub. Date: Jan. 16, 2025

(54) METHOD OF RECOVERING RAW MATERIALS FROM POLYURETHANE PRODUCTS

(71) Applicant: Covestro Deutschland AG, Leverkusen (DE)

(72) Inventors: Sebastian Pohl, Grünstadt (DE); Dirk Hinzmann, Pulheim (DE); Maria Francisco Casal, Leverkusen (DE); Sebastian Scherf, Leverkusen (DE); Lukas Reisky, Köln (DE); Juergen Bausa, Kürten (DE)

(21) Appl. No.: 18/710,344

(22) PCT Filed: Nov. 28, 2022
(86) PCT No.: PCT/EP2022/083538

§ 371 Date: May 15, 2024

(30) Foreign Application Priority Data
Nov. 30, 2021 (EP) 21211420.1

(51) Int. Cl. C08J 11/24

(52) U.S. Cl. CPC C08J 11/24; C08J 2375/04

(57) ABSTRACT

The present invention relates to a method for recovering at least one raw material from a polyurethane product, comprising steps (A) providing a polyurethane product based on an isocyanate component and a polyol component, the isocyanate component comprising only isocyanates for which the corresponding amines have a boiling point at 1013 mbar_{(abs.)} of at most 410° C.; (B) performing chemolysis of the polyurethane product with an alcohol and water; (C) processing the product of the chemolysis, comprising (C.I) extraction with an organic solvent, the boiling point of which at 1013 mbar_{(abs.)} is in the range of 40° C. to 120° C., at a temperature in the range of 10° C. to 60° C., followed by (C.II) phase separation into a first product phase and into a second product phase; and (D) processing the first product phase to obtain the polyol, comprising (D.I.) separation of organic solvent by distillation and/or stripping, and (D.II) separation of amine dissolved in the first product phase by distillation so as to obtain the polyol.

The present invention relates to a method of recovering at least one raw material from a polyurethane product, comprising the steps of (A) providing a polyurethane product based on an isocyanate component and a polyol component, where the isocyanate component comprises only those isocyanates of which the corresponding amines have a boiling point at 1013 mbar_{(abs.)} of not more than 410° C., preferably in the range from 170° C. to 400° C.; (B) chemolyzing the polyurethane product with an alcohol and water; (C) working up the product of the chemolysis, comprising (C.I) extracting with an organic solvent having a boiling point at 1013 mbar_{(abs.)} in the range from 40° C. to 120° C., at a temperature in the range from 10° C. to 60° C., followed by (C.II) phase separation into a first product phase and a second product phase, and (D) working up the first product phase to obtain the polyol, comprising (D.I) separating off organic solvent by distillation and/or stripping and (D.II) separating off amine dissolved in the first product phase by distillation to obtain the polyol.

Polyurethane products enjoy a diversity of applications in industry and in everyday life. Distinctions are typically made between polyurethane foams and what are known as “CASE” products, with “CASE” being a collective term for polyurethane coatings (e.g., paints), adhesives, sealants and elastomers. The polyurethane foams are typically divided into rigid foams and flexible foams. Common to all of these products in spite of their heterogeneity is the basic polyurethane structure, which is formed by the polyaddition reaction of a polyfunctional isocyanate and of a polyol and which in the case, for example, of a polyurethane based on a diisocyanate O═C═N—R—N═C═O and a diol H—O—R′—O—H (where R and R′ denote organic radicals) can be represented as

^{˜˜˜}[O—R′—O—(O═C)—HN—R—NH—(C═O)]^{˜˜˜}.

It is precisely the great economic success of polyurethane products that is responsible for the large amounts of polyurethane waste generated (for example from old mattresses or seating furniture) that must be sent to a sensible use. The mode of reuse that is the easiest to implement technically is that of incineration, with the heat of combustion released being utilized for other processes, examples being industrial processes. However, this does not allow raw material cycles to be completed. Another mode of reuse is called “physical recycling”, which sees polyurethane wastes mechanically comminuted and used in the production of new products. This type of recycling naturally has its limits and there has therefore been no lack of attempts to recover the basic raw materials of polyurethane production by retrocleavage of the polyurethane bonds (called “chemical recycling”). The raw materials to be recovered are firstly polyols (i.e. in the above example H—O—R′—O—H or a polyol that has been formed therefrom in the chemolysis). Secondly, it is also possible through hydrolytic cleavage of the urethane bond to recover amines (i.e., in the example above, H₂N—R—NH₂) which can be phosgenated to afford isocyanates (in the aforementioned example to afford O═C═N—R—N═C═O) after workup.

A variety of chemical recycling approaches have been developed in the past. The three most important are briefly summarized as follows:
1. Hydrolysis of urethanes by reaction with water to recover amines and polyols with formation of carbon dioxide.
2. Glycolysis of urethanes by reaction with alcohols, with replacement of the polyols incorporated in the urethane groups by the alcohol used and hence release of the polyols. This process is commonly referred to in the literature as transesterification (more accurately: transurethanization). Regardless of the exact nature of the alcohol used, this mode of chemical recycling is usually dubbed glycolysis in the literature, a term that really applies only for glycol. In the context of the present invention the term alcoholysis is thus generally used. The glycolysis may be followed by a hydrolysis. If the hydrolysis is performed in the presence of the still-unchanged glycolysis mixture, this is referred to as a
3. Hydroglycolysis of urethane bonds by reaction with alcohols and water. It is of course likewise possible to add alcohol and water from the start, in which case the above-described processes of glycolysis and hydrolysis proceed in parallel.

A summary of the known methods of polyurethane recycling is offered by the review article by Simon, Borreguero, Lucas and Rodriguez in Waste Management 2018, 76, 147-171 [1]. The article highlights glycolysis (2. above) as particularly significant. In glycolysis, a differentiation is made between “biphasic” and “monophasic” regimes depending on whether the obtained crude product of the reaction with the alcohol separates into two phases or not. This depends in particular on the choice of alcohol used and the process conditions (especially the proportion of alcohol used in the reaction mixture and temperature). The aforementioned review article favors the biphasic regime using crude glycerol (wastes from biodiesel production for instance) since it is said to have the greatest potential to recover high-quality products at low production costs (wherein recovery of the polyols is clearly the focus).

As a result of the additional use of water the product of hydroglycolyses (3. above) is always biphasic. Braslaw and Gerlock in Ind. Eng. Chem. Process Des. Dev. 1984, 23, 552-557 [2] describe the workup of this kind of process product, comprising removal of the water (by laboratory-scale phase separation or by evaporation in a process recommended for industrial use and termed the “Ford Hydroglycolysis Process”) and extraction of the remaining organic phase with hexadecane to form an alcohol phase, from which amine can be recovered, and a hexadecane phase, from which polyol can be recovered. Although it mentions the option of recovering amine, the emphasis in this article too is on the recovery of polyols.

A patent for a process operating on these principles was granted under number U.S. Pat. No. 4,336,406. This describes a process for recovery of polyether polyol from a polyurethane, which involves the following steps: (a) forming a solution by dissolving said polyurethane in a saturated alcohol having a boiling point of 225° C. to 280° C. at a temperature of 185° C. to 220° C. under a non-oxidizing atmosphere; (b) refluxing said solution under said non-oxidizing atmosphere in the presence of an alkali metal hydroxide catalyst with water for a time necessary to substantially hydrolyze the dissolution products subject to hydrolysis into amines and alcohol while maintaining said solution at a temperature of 175° C. to 220° C., wherein said alkali metal hydroxide catalyst is included in said solution in an amount in the region of at least 0.1% by mass based on the weight of said polyurethane foam; (c) removing the water remaining after hydrolysis from said solution under a non-oxidizing atmosphere; (d) extracting said polyol from the hydrolyzed solution under a non-oxidizing atmosphere with an alkane substantially immiscible with said alcohol and having a boiling point of 230° C. to 300° C. (especially hexadecane); and (e) subjecting the extracted polyol to vacuum purification at a temperature below about 230° C.

In step (a), the polyurethane is reacted with the alcohol groups of the saturated alcohol to form polyols, ureas and carbamates (see column 3, lines 42 to 46).

In step (b), water and alkali metal hydroxide catalyst are added to the solution obtained in step (a), either separately or in the form of an aqueous catalyst solution, to effect decomposition of carbamates and ureas into amines and alcohol. Steps (a) and (b) in their entirety should be regarded as hydroglycolysis (more accurately: hydroalcoholysis) with a time delay between addition of alcohol and water. Water is added in such an amount that the solution boils at temperatures between 175° C. and 200° C. In the case of diethylene glycol as the alcohol, the water is added in an amount between 2.4% and 0.6%, preferably 1.1%, of the mass of diethylene glycol used (see column 4, lines 39 to 46). Water consumed in the hydrolysis is replaced by addition of further water in order to keep the water content constant. After hydrolysis, the water used has to be removed in step (c) (column 5, lines 31 to 33) before the extraction in step (e) can be carried out.

U.S. Pat. No. 4,317,939 describes a process in which a polyurethane foam is first dissolved in alcohol, then water and a catalyst are added, and the reaction mixture is heated under reflux. The resulting reaction product is either monophasic, in which case it is purified by vacuum distillation, or biphasic, in which case a polyol phase is removed and purified by vacuum distillation. The polyols recovered in this way may be used in the production of new polyurethane foams.

Only a few of the chemical recycling processes known from the literature are in sustained operation on an industrial scale; many have not even reached pilot scale [1]. In view of generally increased environmental awareness and increased efforts to configure industrial processes to be as sustainable as possible—both of which are fundamentally in favor of chemical recycling—this shows clearly that the chemical recycling of polyurethane products is still by no means mature from a technical and economic point of view. Challenges exist particularly with regard to the purity of the products recovered. Polyols must be recovered without amine impurities if at all possible, in order, for instance, not to adversely affect foaming characteristics in the case of reuse in the production of polyurethane foams. If another aim is recovery of amines, these must of course also be obtained in maximum purity. In addition, the polyurethane products to be reutilized usually still contain various auxiliaries and additives (stabilizers, catalysts and the like), which have to be separated from the actual target products of the recycling and disposed of in an economically viable and environmentally benign manner. Moreover, an economic recycling process must ensure that the reagents used (for example alcohols used) can be recovered and reused (i.e. follow a closed loop) as completely as possible.

International patent application WO 2020/260387 A1 is concerned with the solution of such difficulties. This describes a method of recovering raw materials from polyurethane products that comprises the following steps: (A) providing a polyurethane product based on an isocyanate and a polyol; (B) reacting the polyurethane product with a (mono—or polyhydric) alcohol in the presence of a catalyst, to give a first product mixture; (C) recovering polyols from the first product mixture, comprising (C.I) combining the first product mixture, obtained in step (B)—without prior removal of any water present in the first product mixture—with an organic solvent which is not fully miscible with the alcohol used in step (B), and performing phase separation into a first alcohol phase and a first solvent phase; and (C.II) working up the first solvent phase to recover polyols; and preferably (D) recovering amines. Even though the method described offers promising approaches to a solution in respect of the problems mentioned, and in particular shows a way in which the amine can be recovered in an efficient and environmentally benign manner with simultaneously elegant discharge of accompanying substances that originate from the polyurethane product (for example stabilizers), it is not entirely free of drawbacks. For instance, the polyol phase is obtained in a mixture with carbamates (albeit in small amounts), which have to be separated off and have a very high boiling point, which makes it difficult to remove them by simple distillation.

There was thus a need for further improvements in the field of chemical recycling of polyurethanes. In particular, it would be desirable to be able to recover polyols and preferably also amines in high purity and efficiently from polyurethane products, especially in a manner that would make industrial scale use economically achievable. For this purpose, a method in which the chemolysis and the workup of the crude processed product from the chemolysis are configured such that the polyols can be recovered in maximum purity with a minimum level of complexity would be desirable.

Taking account of this requirement, the present invention provides a method of recovering at least one raw material from a polyurethane product, comprising the steps of:
(A) providing a polyurethane product based on an isocyanate component and a polyol component, where the isocyanate component comprises only those isocyanates of which the corresponding amines have a boiling point at 1013 mbar_{(abs.)} of not more than 410° C., preferably in the range from 170° C. to 400° C.;
(B) reacting the polyurethane product with a stoichiometric excess of an alcohol and a stoichiometric excess of water (=chemolysis) in the presence of a catalyst in the liquid phase to obtain a chemolysis product comprising alcohol (the alcohol unconverted in the chemolysis), water (the water unconverted in the chemolysis), (at least) a polyol (especially from the polyol component or possibly a polyol that has formed from the polyol component in the chemolysis) and (at least) an amine corresponding to an isocyanate of the isocyanate component;
(C) working up the chemolysis product, comprising
   (C.I) extracting, optionally with addition of further water, the chemolysis product with an organic solvent having a boiling point at 1013 mbar_{(abs.)} in the range from 40° C. to 120° C., at a temperature in the range from 10° C. to 60° C., followed by
   (C.II) phase separation
      into a first product phase comprising the organic solvent (at least the majority thereof), the polyol (at least the majority thereof) and a first (relatively small) portion of the amine, with or without a first (relatively small) portion of the alcohol,
      and
      a second product phase comprising the alcohol (at least the majority thereof, possibly only a second (greater) portion of the alcohol), the water (at least the majority thereof) and a second portion (=the majority) of the amine;
and
(D) working up the first product phase to obtain the polyol, comprising:
   (D.I) separating off the organic solvent (at least the majority thereof) by distillation and/or stripping, and
   (D.II) separating off the first portion of the amine by distillation to obtain the polyol (i.e. the at least one raw material).

Entirely surprisingly, it has been found that, in the case of polyurethane products as specified in (A), the configuration of the chemolysis as hydroalcoholysis and the configuration of the workup of the chemolysis product with extraction with an organic solvent, the boiling point of which at 1013 mbar_{(abs.)} is in the range from 40° C. to 120° C., at a temperature in the range from 10° C. to 60° C., makes it possible to obtain the polyol in high purity in subsequent workup steps in a simple manner.

Polyurethane products in the context of the present invention are the polyaddition products (occasionally also referred to, albeit not entirely correctly, as polycondensation products) of polyfunctional isocyanates (=isocyanate component in the polyurethane preparation) and polyols (=polyol component in the polyurethane preparation). Polyurethane products generally contain, as well as the polyurethane base structure outlined above, other structures as well, for example structures having urea bonds. The presence of such structures diverging from the pure polyurethane base structure in addition to polyurethane structures does not depart from the scope of the present invention.

An amine corresponding to an isocyanate is the amine that can be phosgenated to obtain the isocyanate according to R—NH₂+COCl₂→R—N═C═O+2 HCl. In the terminology of the present invention, the term isocyanates encompasses all isocyanates known to a person skilled in the art in connection with polyurethane chemistry, provided that their corresponding amines meet the conditions specified in (A). Isocyanates in the context of the present invention are especially tolylene diisocyanate (TDI; the corresponding amine is tolylenediamine, TDA), the diisocyanates of the diphenylmethane series (“monomeric MDI”, mMDI; the corresponding amines are the diamines of the diphenylmethane series, mMDA), pentane 1,5-diisocyanate (TDI; the corresponding amine is pentane-1,5-diamine, PDA), hexamethylene 1,6-diisocyanate (HDI; the corresponding amine is hexamethylene-1,6-diamine, HDA), isophorone diisocyanate (IPDI; the corresponding amine is isophoronediamine, IPDA) and xylylene diisocyanate (XDI; the corresponding amine is xylylenediamine, XDA). The expression “an isocyanate” does of course also encompass embodiments in which two or more different isocyanates (e.g. mixtures of MDI and TDI) were used in the production of the polyurethane product, unless explicitly stated otherwise, for instance by the wording “exactly one isocyanate”. The entirety of all isocyanates used in the preparation of the polyurethane product is referred to as isocyanate component (of the polyurethane product). The isocyanate component comprises at least one isocyanate. Analogously, the entirety of all polyols used in the preparation of the polyurethane product is referred to as polyol component (of the polyurethane product). The polyol component comprises at least one polyol.

In the terminology of the present invention, the term polyols encompasses all polyols known to a person skilled in the art in connection with polyurethane chemistry, such as, in particular, polyether polyols, polyester polyols, polyetherester polyols, polyacrylate polyols and polyethercarbonate polyols. The expression “a polyo” does of course also encompass embodiments in which two or more different polyols were used in the production of the polyurethane product. Therefore, if reference is made hereinafter, for example, to “a polyether polyol”, this terminology does of course also encompass embodiments in which two or more different polyether polyols were used in the production of the polyurethane product. The term polyol can also represent a polyol that has been formed in the chemolysis from the polyol originally used in the production of the polyurethane product. As elucidated in even more detail further down, however, the polyols of the polyol component are preferably polyether polyols or polyacrylate polyols that can be recovered as such in the chemolysis.

The wording “reacting the polyurethane product with a stoichiometric excess of an alcohol and a stoichiometric excess of water” does not necessarily imply that all of the water to be used in step (B) need immediately be added on commencement of step (B). Instead, embodiments in which, on commencement of step (B), at first no water or only a portion of the water is added and the water/the remaining water is added successively during the reaction duration are encompassed by the invention. In principle, it is also conceivable to add the alcohol or a mixture of water and alcohol gradually.

In the method of the invention, water and alcohol are used in superstoichiometric amounts. This means that water is used in an amount theoretically sufficient to hydrolyze all the polyurethane bonds to give amines and polyols with release of carbon dioxide. Similarly, the use of superstoichiometric amounts of alcohol means that said alcohol is used in an amount that is theoretically sufficient to convert all of the polyurethane bonds to form carbamates and polyols.

The appended drawings show:

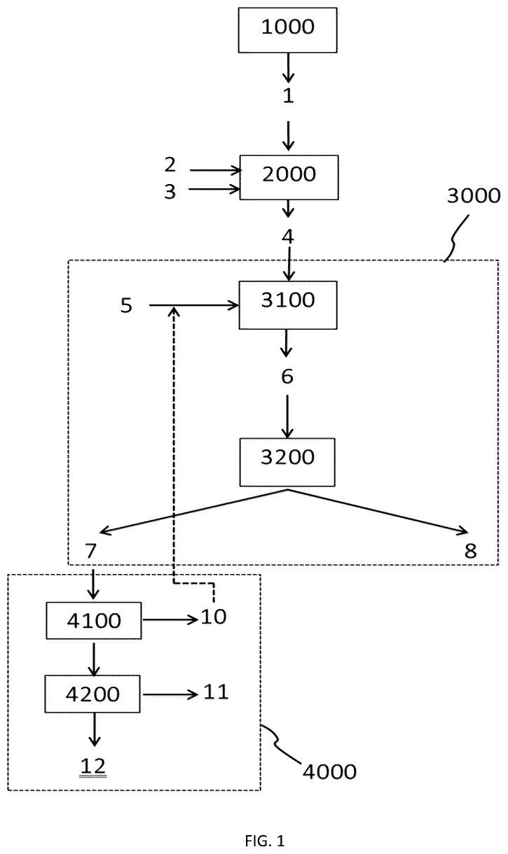

FIG. 1 a schematic visualization of the method of the invention for obtaining at least the polyol raw material (12).

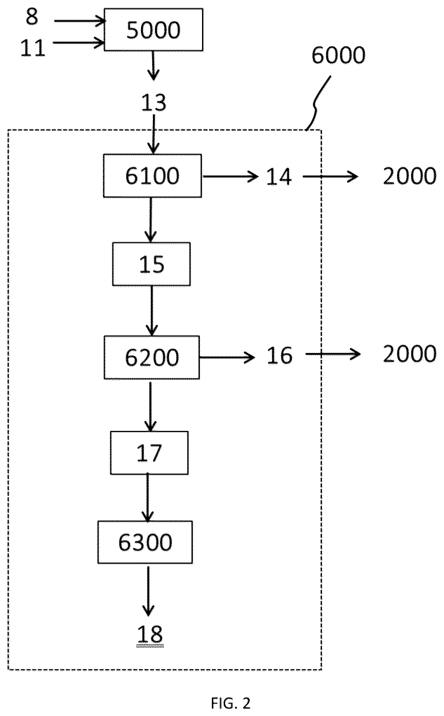

FIG. 2 the schematic diagram of a preferred embodiment of the method of the invention for obtaining the amine raw material (18) as well.

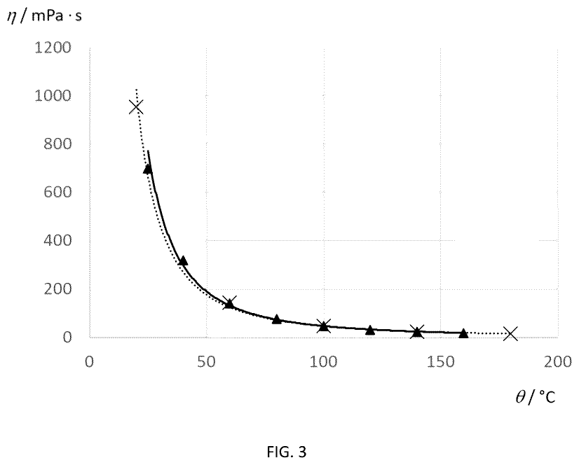

FIG. 3 the dynamic viscosity at different temperatures of a polyol recovered by the method of the invention by comparison with a fresh polyol of the same type.

There will firstly follow a brief summary of various possible embodiments of the invention:

In a first embodiment of the invention, which can be combined with all other embodiments, in a step (E), the first portion of the amine is added to the second product phase and worked up jointly therewith in a step (F) to obtain the amine.

In a second embodiment of the invention, which can be combined with all other embodiments, in a step (G), the organic solvent separated off in step (D.I) is fed to step (C.I).

In a third embodiment of the invention, which can be combined with all other embodiments, in step (D.I), the organic solvent is first separated off in a first stage as a solvent fraction, and then an alcohol fraction (containing the first (relatively small) portion of the alcohol, and possibly a (relatively small) portion of the organic solvent) is separated off in a second stage.

In a fourth embodiment of the invention, which is a particular configuration of the third embodiment, the second stage is conducted in a thin-film evaporator, short-path evaporator or flash evaporator.

In a fifth embodiment of the invention, which is a particular configuration of the third and fourth embodiments, the alcohol fraction separated off in the second stage is fed to step (B).

In a sixth embodiment of the invention, which is a further particular configuration of the third and fourth embodiments, the alcohol fraction separated off in the second stage is separated into an alcoholic phase and a solvent phase, wherein the alcoholic phase is fed to step (B) and the solvent phase to step (C.I).

In a seventh embodiment of the invention, which can be combined with all other embodiments, the separating-off of the organic solvent in step (D.I) is performed in a falling-film evaporator, natural circulation evaporator, tank evaporator, forced circulation evaporator or flash evaporator.

In an eighth embodiment of the invention, which can be combined with all other embodiments, the separating-off of the first portion of the amine in step (D.II) is performed in a thin-film evaporator, short-path evaporator or flash evaporator.

In a ninth embodiment of the invention, which can be combined with all other embodiments, the separating-off of the first portion of the amine in step (D.II) is performed at a pressure of 0.1 mbar_{(abs.)} to 5.0 mbar_{(abs.)} and at a temperature of 140° C. to 240° C.

In a tenth embodiment of the invention, which can be combined with all other embodiments, in step (B),
(I) the polyurethane product is firstly admixed solely with (α) the alcohol (=variant (α)) or (β) the alcohol (=variant (β)) and a first portion of the water, and then
(II) water (α) or a second portion of the water (β) is added, especially only after the polyurethane product has gone into solution.

In an eleventh embodiment of the invention, which is a particular configuration of the tenth embodiment, in step (II), the water (α) or the second portion of the water (β) is added continuously or in portions such that the temperature of the liquid phase during step (II) differs by a maximum of 20° C., preferably by a maximum of 15° C., more preferably by a maximum of 10° C., even more preferably by a maximum of 5.0° C. and very exceptionally preferably by a maximum of 1.0° C. from the temperature of the liquid phase of the chemolysis reactor in step (I).

In a twelfth embodiment of the invention, which is a particular configuration of the tenth and eleventh embodiments, in variant (β), the first portion of the water is up to 4.0%, especially 2.0% to 4.0%, of the mass of the water added overall in step (B) (i.e. in (I) and (II) together).

In a thirteenth embodiment of the invention, which can be combined with all other embodiments, step (B) is performed at a temperature in the range from 140° C. to 220° C., preferably 170° C. to 200° C.

In a fourteenth embodiment of the invention, which can be combined with all other embodiments, the mass ratio of alcohol (used in total) and water (used in total) on the one hand to the polyurethane product on the other hand (i.e. [m(alcohol)+m(water)]/m (polyurethane product), m=mass) is in the range from 0.5 to 2.5, where the mass of water is 2.0% to 10% of the mass of the alcohol.

In a fifteenth embodiment of the invention, which may be combined with all other embodiments, the alcohol is selected from ethylene glycol, diethylene glycol, propylene glycol, dipropylene glycol, methyl glycol, triethylene glycol, glycerol, 2-methylpropane-1,3-diol or a mixture of two or more of the aforementioned alcohols.

In a sixteenth embodiment of the invention, which can be combined with all other embodiments, the catalyst is selected from a carbonate, a hydrogencarbonate, an orthophosphate, a monohydrogenorthophosphate, a metaphosphate, a hydroxide (with use of the aforementioned catalysts especially in the form of alkali metal salts or alkaline earth metal salts), an organic amine, an organometallic compound or a mixture of two or more of the aforementioned catalysts.

In a seventeenth embodiment of the invention, which can be combined with all other embodiments, the mass of the catalyst is 0.1% to 3.5% of the mass of the polyurethane product.

In an eighteenth embodiment of the invention, which can be combined with all other embodiments, the isocyanate component comprises an isocyanate selected from tolylene diisocyanate, the diisocyanates of the diphenylmethane series, pentane 1,5-diisocyanate, hexamethylene 1,6-diisocyanate, isophorone diisocyanate, xylylene diisocyanate or a mixture of two or more of the abovementioned isocyanates.

In a nineteenth embodiment of the invention, which is a particular configuration of the eighteenth embodiment, the isocyanate component comprises tolylene diisocyanate or a mixture of tolylene diisocyanate and the diisocyanates of the diphenylmethane series.

In a twentieth embodiment of the invention, which is a particular configuration of the nineteenth embodiment, the isocyanate component comprises tolylene diisocyanate.

In a twenty-first embodiment of the invention, which is a particular configuration of the twentieth embodiment, the isocyanate component does not comprise any further isocyanates aside from tolylene diisocyanate.

In a twenty-second embodiment of the invention, which can be combined with all other embodiments, the polyol component comprises a polyether polyol, a polyester polyol, a polyetherester polyol, a polyacrylate polyol and/or a polyethercarbonate polyol. The polyol component preferably contains a polyether polyol. More preferably, the polyol component is a polyether polyol (i.e. does not contain any polyols other than polyether polyols; but a mixture of two or more different polyether polyols is encompassed and does not depart from the scope of this embodiment).

In a twenty-third embodiment of the invention, which is a particular configuration of the twenty-second embodiment, the polyether polyol is a styrene-acrylonitrile copolymer-filled polyether polyol.

In a twenty-fourth embodiment of the invention, which can be combined with all other embodiments, the organic solvent is selected from an aliphatic hydrocarbon (especially hexane), a cycloaliphatic hydrocarbon (especially cyclohexane), an aromatic hydrocarbon (especially toluene) or a mixture of two or more of the aforementioned solvents.

The embodiments outlined briefly above and further possible configurations of the invention are more particularly elucidated hereinbelow. All the above-described embodiments and the further configurations of the invention described below are mutually and collectively combinable as desired unless the opposite is clearly apparent from the context to a person skilled in the art or is expressly stated.

### Providing the Polyurethane Product for Chemical Recycling

Step (A)—1000 in FIG. 1—of the method of the invention comprises providing the polyurethane product (1) to be chemically recycled in preparation for the chemolysis.

This may in principle be any kind of polyurethane product; however, polyurethane foams are preferred, especially flexible polyurethane foams. Polyurethane foams are typically produced using pentane, dichloromethane and/or carbon dioxide as blowing agents.

In addition, preference is given to polyurethane products that are based, with regard to the isocyanate component, on an isocyanate selected from tolylene diisocyanate (TDI), the diisocyanates of the diphenylmethane series (mMDI), pentane 1,5-diisocyanate (PDI), hexamethylene 1,6-diisocyanate (HDI), isophorone diisocyanate (IPDI), xylylene diisocyanate (XDI) and mixtures of two or more of the aforementioned isocyanates. Particular preference is given to polyurethane products that are based on TDI and/or mMDI with regard to the isocyanate component, where TDI is very especially preferred. Very exceptionally preferably, the isocyanate component does not comprise any further isocyanates aside from TDI. If the isocyanate of the isocyanate component is in the form of various isomers, as is the case, for example, for the particularly preferred isocyanates TDI and mMDI, the isomer distribution is of no importance for the present invention.

With regard to the polyol component, preference is given to polyurethane foams that are based on a polyol selected from a polyether polyol, a polyester polyol, a polyetherester polyol, a polyethercarbonate polyol, a polyacrylate polyol or a mixture of two or more of the aforementioned polyols, particular preference being given to polyether polyols and polyacrylate polyols. Most preferably, the polyol component contains a polyether polyol. Very exceptionally preferably, the polyol component is a polyether polyol (i.e. does not contain any polyols other than polyether polyols; but a mixture of two or more different polyether polyols is encompassed and does not depart from the scope of this embodiment). The polyether polyol may also be one that is filled with a styrene-acrylonitrile copolymer (SAN copolymer). It is one of the advantages of the invention that it is also applicable to such polyol components. The challenge in the chemolysis of polyurethane products having a polyol component based on SAN copolymer-filled polyether polyols is that the SAN copolymer can be released as finely divided polymer particles during the chemolysis. This applies regardless of the chemolysis method chosen. The SAN polymer present as finely divided polymeric particles in the reaction mixture leads to problems in the subsequent separation by extractive methods for example. Furthermore, due to the fineness of the polymer particles, filtration is hardly possible since the filter quickly becomes blocked and further removal is no longer possible. The advantage of the hydroalcoholysis according to the invention is that after its liberation from the polyether polyol the SAN polymer is partially brought into a soluble form by the hydrolysis step, thus allowing the workup of the reaction mixture after the chemolysis by extraction to proceed without issue.

Most preferably, the polyurethane product is one wherein the isocyanate component contains either TDI or mMDI, especially TDI (and does not contain any other isocyanates), and wherein the polyol component contains a polyether polyol (and in particular is a polyether polyol, i.e. does not contain any further polyols other than polyether polyols, although a mixture of two or more different polyether polyols is included and does not depart from the scope of this embodiment).

Preferably, even step (A) comprises preparatory steps for the cleavage of the urethane bonds in step (B). These are especially mechanical comminution of the polyurethane products. Such preparatory steps are known to a person skilled in the art; reference is made by way of example to the literature cited in [1]. Depending on the characteristics of the polyurethane product, it may be advantageous to “freeze” it before the mechanical comminution in order to facilitate the comminuting operation; this is especially true of polyurethane foams.

It is also conceivable to conduct the above-described preparatory steps at a site spatially separate from the site of the chemolysis. In that case, the prepared polyurethane product is transferred into suitable transport vehicles, for example silo vehicles, for further transport. For further transport the prepared polyurethane product, especially in the case of a polyurethane foam, may additionally be compressed to achieve a higher mass-to-volume ratio. The polyurethane product is then transferred into the reaction apparatus provided for the chemolysis at the location of the chemolysis. It is also conceivable to connect the transport vehicle used directly to the reaction apparatus.

### Chemolysis of the Polyurethane Product to Obtain the Chemolysis Product

Step (B) of the method of the invention—2000 in FIG. 1—comprises the chemolysis of the polyurethane product provided in step (A) with an alcohol (2) and water (3).

The chemolysis is preferably carried out in the absence of oxygen. This means that the reaction is carried out in an inert gas atmosphere (especially in a nitrogen, argon or helium atmosphere). It is also preferable to free the chemolysis reagents used (water and alcohol) of oxygen by inert gas saturation.

The chemolysis is preferably conducted at temperatures of 140° C. to 220° C., preferably 170° C. to 200° C. There are no particular demands with regard to pressure. The reaction can be conducted either at reduced or elevated pressure; for example at a pressure of 200 mbar_{(abs.)} to 2000 mbar_{(abs.)}, preferably 500 mbar_{(abs.)} to 1500 mbar_{(abs.)}, more preferably 900 mbar_{(abs.)} to 1300 mbar_{(abs.)} and especially at ambient pressure.

Suitable alcohols (2) for step (B) are in particular ethylene glycol, diethylene glycol, propylene glycol, dipropylene glycol, methylglycol, triethylene glycol, glycerol, 2-methylpropane-1,3-diol, or mixtures of two or more of the aforesaid alcohols. Suitable catalysts for step (B) are in particular carbonates, hydrogencarbonates, orthophosphates, monohydrogenorthophosphates, metaphosphates, hydroxides (with use of the aforementioned catalysts especially in the form of alkali metal salts or alkaline earth metal salts), organic amines, organometallic compounds or mixtures of two or more of the aforementioned catalysts. The catalyst is preferably used in such an amount that the mask thereof is 0.1% to 3.5% of the mass of the polyurethane product.

Step (B) is preferably conducted in such a way that the mass ratio of alcohol (used in total) and water (used in total) on the one hand to the polyurethane product on the other hand (i.e. [m(alcohol)+m(water)]/m(polyurethaneproduct), m=mass) is in the range from 0.5 to 2.5, where the mass of water is 2.0% to 10% of the mass of the alcohol. The quantitative figures in respect of water in the context of present invention relate to the water added as a reagent for the hydrolytic carbamate cleavage. By comparison, any amounts of water emanating from moisture that are present in any case in the alcohol used and/or in the polyurethane product used are low. Moisture in the alcohol used or in the polyurethane product used means traces of moisture as can occur on an industrial scale. It is of course possible to premix the alcohol with water to be used for the hydrolytic cleavage or to wet the polyurethane product with water to be used for the hydrolytic cleavage. Such embodiments do not depart from the scope of the invention and water added in this way should of course be taken into account in the quantitative figures given above, i.e. the amount of water additionally to be added if required should be reduced correspondingly.

If the catalyst is used in the form of an aqueous solution, the water used as solvent should likewise be taken into account in the quantitative figures given above, i.e. the amount of water additionally to be added if required should be reduced correspondingly.

As already mentioned, it is unnecessary to add all the water right at the start of step (B). In this case, the above-stated amount of “2.0% to 10% of the mass of the alcohol” relates to the amount of water added in total up to the end of the reaction time of step (B). If the alcohol is added gradually, the same applies.

In particular, it is also possible, in step (B),
(I) first to admix the polyurethane product solely with (α) the alcohol or (β) the alcohol and a first portion of the water, and then
II) to add water (α) or a second portion of the water (β), especially only after the polyurethane product has gone into solution.

The expression “gone into solution” in this connection does not necessarily imply the presence of a “true” solution in the sense of a completely homogeneous mixture. It may quite possibly be the case that there is a “cloudy” solution of the polyurethane product; this does not leave the scope of the present invention.

In the course of performance of step (B) in steps (I) and (II), it is especially preferable, in step (II), to add the water (α) or the second portion of the water (β) continuously or in portions such that the temperature of the liquid phase during step (II) differs by a maximum of 20° C., preferably by a maximum of 15° C., more preferably by a maximum of 10° C., even more preferably by a maximum of 5.0° C. and very exceptionally preferably by a maximum of 1.0° C. from the temperature of the liquid phase in step (I). What this achieves is that the temperature is always high enough to assure progression of the chemolysis. If a portion of the water is already added at the start of the chemolysis (=variant (β)), it is preferable that the first portion of the water is up to 4.0%, especially 2.0% to 4.0%, of the mass of the total amount of water added in step (B) (i.e. in (I) and (II) together).

### Obtaining the Polyol

Step (B) affords a chemolysis product (4) containing
(at least) an amine corresponding to an isocyanate of the isocyanate component,
(at least) a polyol (from the polyol component or formed from the latter in step (B)),
(superstoichiometrically used and therefore incompletely converted) alcohol and
(superstoichiometrically used and therefore incompletely converted) water.

In the steps that follow, this chemolysis product is worked up to recover the polyol raw material.

This workup firstly includes—see also FIG. 1—step (C) (3000 in FIG. 1), in which the chemolysis product is subjected to an extraction (step (C.I)—3100 in FIG. 1) and phase separation (step (C.II)—3200 in FIG. 1). According to the invention, the extractant used in step (C.I) is an organic solvent (5) having a boiling point at 1013 mbar_{(abs.)} in the range from 40° C. to 120° C. Suitable organic solvents are in particular aliphatic hydrocarbons (for example hexane), cycloaliphatic hydrocarbons (for example cyclohexane), aromatic hydrocarbons (for example toluene) or mixtures of two or more of the aforementioned solvents). The extraction is conducted at a temperature of 10° C. to 60° C. (for example ambient temperature).

The process product of the extraction (6) is biphasic and is separated into its phases in step (C.II). It may be advantageous to add further water in the extraction in order to facilitate this phase separation. One of the phases obtained in step (C.II) contains the organic solvent (at least the majority thereof), the polyol (at least the majority thereof) and a first (relatively small) portion of the amine, with or without a first (relatively small) portion of the alcohol. This phase is referred to in the terminology of the present invention as first product phase (7). Since this phase contains at least the majority of the polyol, it can also be referred to as polyol phase. The second phase contains the alcohol (at least the majority thereof, possibly also only a second (greater) portion of the alcohol), the water (at least the majority thereof) and a second portion (=the majority) of the amine. This phase is referred to in the terminology of the present invention as second product phase (8). Since this phase contains the majority of the amine, it can also be referred to as amine phase. In step (C), the separation (of the majorities) of amine and polyol is thus effected. It will be self-evident to the person skilled in the art that this separation need not necessarily proceed perfectly in the sense that all polyol goes into the first product phase and all amine into the second product phase. As a result of the prevailing solubility equilibria, it is regularly the case that small amounts of the amine get into the first product phase. Nor is it unusual that small amounts of the polyol get into the second product phase; this of course does not leave the scope of the present invention.

Step (C.II) is then followed by the obtaining of the polyol from the first product phase in step (D) (4000 in FIG. 1). For this purpose, first of all, in a step (D.I) (4100 in FIG. 1), the organic solvent is separated off largely to completely by distillation and/or stripping (10). For this purpose, preference is given to using a falling-film evaporator, natural circulation evaporator, tank evaporator, forced circulation evaporator or flash evaporator. The organic solvent separated off is preferably fed, optionally after a purification, to step (C.I) in a step (G), where it is used as extractant (shown by a dotted arrow in FIG. 1).

After the organic solvent has been separated off, the amine dissolved in the first product phase (=the first portion of the amine) is separated by distillation (11), leaving purified polyol (12) (step (D.II); 4200 in FIG. 1). This separating-off of the first portion of the amine (11) is preferably effected in a thin-film evaporator, short-path evaporator or flash evaporator, especially at pressures of 0.1 mbar_{(abs.)} to 5.0 mbar_{(abs.)} and temperatures of 140° C. to 240° C.

As already mentioned, the first product phase may also contain fractions of the alcohol used in the chemolysis. This can be separated off together with the first portion of the amine in step (D.II) and is then part of stream 11. As elucidated in even more detail further down, it is preferable for the obtaining of the amine to feed the first portion of the amine (11) to the second product phase in a step (E) and to work it up together therewith. This is also possible without difficulty in the described case that stream 11 contains fractions of the alcohol, since the second product phase contains the majority of the alcohol in any case.

However, it is also possible, in step (D.I), firstly in a first stage, to separate off the organic solvent as a solvent fraction (which is advantageously fed to step (C.I)) and then, in a second stage, an alcohol fraction (containing the first (relatively small) portion of the alcohol and possibly a (relatively small) portion of the organic solvent). Suitable apparatuses for the second stage are especially the same as for step (D.II), i.e. thin-film evaporators, short-path evaporators or flash evaporators. The alcohol fraction separated off in the second stage may still contain solvent fractions and may possibly separate spontaneously into two phases, namely into an alcohol phase and a solvent phase. The alcoholic phase is preferably fed to step (B), and the solvent phase (like the solvent fraction) to step (C.I). If there is no spontaneous phase separation, it is preferable to feed the alcohol fraction to step (B). The described two-stage performance of step (D.I) enables separate recovery of fractions of unconverted alcohol dissolved in the first product phase, and is therefore advisable especially when such proportions are comparatively large.

### Obtaining the Amine

It is preferable to work up the second product phase (8) obtained in step (C.II) to recover the further amine raw material. Appropriately (in this regard see also FIG. 2), the first portion of the amine (11) separated off in step (D.II), in a step (E) (5000 in FIG. 2), is mixed with the second product phase (8), and the mixture obtained (13) is worked up to obtain the amine (18) (step (F); 6000 in FIG. 2). Since, as already mentioned, the second product phase (8) contains the alcohol used in the chemolysis (at least the majority thereof, possibly also only a second (relatively large) portion of the alcohol), the water (at least the majority thereof) and a second portion (=the majority) of the amine, and the first portion of the amine (11), as well as the amine, possibly also contains fractions of the alcohol used in the chemolysis, the mixture 13 consists essentially of amine, water and alcohol.

This amine-water-alcohol mixture (13) is subjected to an evaporation process to obtain the amine. This is preferably accomplished in two stages, wherein, in a first stage (step (F.I); 6100 in FIG. 2), water (14) is evaporated, leaving an amine-alcohol mixture (15), and, in a second stage (step (F.II); 6200 in FIG. 2), an alcohol fraction (16) is evaporated, leaving a prepurified amine phase (17). If the amine-water-alcohol mixture (13) should still contain fractions of organic solvent (5) (which cannot be ruled out depending on the position of the solvent equilibria), this is preferably distilled off prior to the evaporation of water, or, depending on the position of the boiling points (or the existence of azeotropically boiling mixtures), optionally together with the water (followed by a phase separation), or else after water has been separated off. Water separated off in step (F) is preferably used as a constituent of the water (3) used in step (B) (2000 in the figures). Water required additionally may come from other customary water sources (for example fresh water or steam condensate).

The alcohol fraction (16) obtained in the second evaporation stage (step (F.II); 6200 in FIG. 2) is preferably (optionally after purification) recycled into step (B) (2000 in the figures), where it is used as a constituent of the alcohol (2) used for the chemolysis.

The amine (18) is then isolated from the prepurified amine phase (17). The workup required for the purpose (step (F.III); 6300 in FIG. 2) is preferably effected by distillation.

In a particularly advantageous configuration of the amine workup, which offers an economic and environmentally benign outlet for impurities originating from the polyurethane product, the obtaining of the amine from the amine phase (8) is incorporated into the workup of newly prepared amine, in that the amine phase is mixed into a crude product fraction of the amine coming from the new production of the amine. This embodiment is described in detail in international patent application WO 2020/260387 A1 (page 23, line 31 to page 27, line 7), to which reference is made at this point.

The examples which follow are intended to further illustrate the invention.

### EXAMPLES

### Analysis

The hydroxyl number (also called OHN, with the unit mg KOH/g) is a standard method of determining polyol properties and was determined as follows:

The polyol is admixed with an excess of phthalic anhydride (PA). The remaining PA is hydrolyzed with water. Each OH group reacts with an anhydride group to form an ester. The COOH groups released from the PA can be titrated with a KOH solution, which permits calculation of the number of OH groups.

The amine value was determined by titration of the amine nitrogen with 0.1 M perchloric acid in acetic acid. Analogously to the OHN, it is reported in mg KOH/g of substance examined.

The viscosity of the polyols examined (polyol originally used and polyol recovered) was measured with a heatable MCR 301 rotary viscometer from Anton Paar in the temperature range from 20° C. to 180° C.

### Example 1 (Inventive)

An initial charge of 300 g of diethylene glycol (DEG, 2) and 5.4 g of Na₂CO₃ in a round-bottom flask was heated up to 180° C. Subsequently, 300 g of TDI-based polyurethane foam (1) was added stepwise. Once the total amount of foam had been added, the reaction mixture obtained was kept at 180° C. for a further 3 h. After the reaction time, 17 g of demineralized (DM) water (3) was added stepwise to the reaction mixture at 180° C. (hydroglycolysis step). Subsequently, the reaction mixture was kept at 180° C. for a further 2.5 h. (Steps (A) and (B); (in FIGS. 1 1000 and 2000).)

The resultant reaction mixture (4) was contacted continuously with 3 parts by mass of cyclohexane (5) (step (C.I); in FIG. 1 3100)), which resulted in formation of a polyol-rich phase (light phase, first product phase, 7) and a DEG-rich phase (heavy phase, second product phase, 8). The phases were separated (step (C.II); (in FIG. 1 3200).

First of all, the majority of the cyclohexane (10) was removed from the light phase with a rotary evaporator in a batchwise evaporation. For this purpose, the mixture was heated in a round-bottom flask heated by oil bath at 120° C. and 20 mbar_{(abs.)} until condensing ceased (step (D.I); in FIG. 1 4100).

The cyclohexane-depleted mixture thus obtained was fed continuously to a short-path evaporator at 190° C. and <5 mbar_{(abs.)} The evaporable vapors (11, containing DEG and TDA, first portion of the amine) precipitated out here on the internal water-cooled cooling coil (step (D.II); in FIG. 1 4200).

The polyol (12, regenerate polyol) obtained in this way was analyzed, and the following OH numbers and amine values were ascertained:

OHN: 49.1 mg KOH/g, amine value: 0.36 mg KOH/g.

The polyol (original polyol) originally used in the production of the converted polyurethane foam has the following values:

OH number: 48.0 mg KOH/g, amine value: 0.00 mg KOH/g.

It can be seen that the regenerate polyol is very similar to the original polyol with regard to the essential properties of OH number and amine value. This is confirmed by a comparison of the viscosities at different temperatures. In this regard, reference is made to FIG. 3, in which the temperature θ in ° C. is shown on the abscissa axis and the dynamic viscosity η in mPa·s on the ordinate axis. The values for the regenerate polyol are identified by an “X”, and those for the original polyol by a black triangle. The lines (dashed for the original polyol and solid for the regenerate polyol) represent power functions fitted to the measurement points. It can be seen that these functions are largely congruent.

1. A method of recovering at least one raw material from a polyurethane product, comprising:
(A) providing a polyurethane product based on an isocyanate component and a polyol component, where the isocyanate component comprises only those isocyanates of which the corresponding amines have a boiling point at 1013 mbar_{(abs.)} of not more than 410° C.;
(B) reacting the polyurethane product with a stoichiometric excess of an alcohol and a stoichiometric excess of water in the presence of a catalyst in the liquid phase to obtain a chemolysis product comprising alcohol, water, a polyol and an amine corresponding to an isocyanate of the isocyanate component;
(C) working up the chemolysis product, wherein the working up of the chemolysis product comprises:
(C.I) extracting the chemolysis product with an organic solvent having a boiling point at 1013 mbar_{(abs.)} of 40° C. to 120° C., wherein the extracting occurs at a temperature of 10° C. to 60° C., followed by
(C.II) phase separation into a first product phase comprising the organic solvent, the polyol and a first portion of the amine, with or without a first portion of the alcohol, and a second product phase comprising the alcohol, the water and a second portion of the amine; and
(D) working up the first product phase to obtain the polyol, wherein the working up of the first product phase comprises:
(D.I) separating off the organic solvent by distillation and/or stripping, and
(D.II) separating off the first portion of the amine by distillation to obtain the polyol.

2. The method as claimed in claim 1, further comprising:
(E) adding the first portion of the amine to the second product phase; and
(F) jointly working up the first portion of the amine and the second product phase to obtain the amine.

3. The method as claimed in claim 1 further comprising:
(G) feeding, to step (C.I), the organic solvent separated off in step (D.I).

4. The method as claimed in claim 1, in which, in step (D.I), the organic solvent is first separated off in a first stage as a solvent fraction, and then an alcohol fraction is separated off in a second stage.

5. The method as claimed in claim 4, in which
the alcohol fraction separated off in the second stage is fed to step (B);
or in which
the alcohol fraction separated off in the second stage is separated into an alcoholic phase and a solvent phase, wherein the alcoholic phase is fed to step (B) and the solvent phase to step (C.I).

6. The method as claimed in claim 1, in which, in step (B),
(I) the polyurethane product is first admixed solely with (α) the alcohol or (β) the alcohol and a first portion of the water, and then
(II) water (α) or a second portion of the water (β) is added.

7. The method as claimed in claim 6, in which, in step (II), the water (α) or the second portion of the water (β) is added continuously or in portions such that the temperature of the liquid phase during step (II) differs by a maximum of 20° C. from the temperature of the liquid phase of the chemolysis reactor in step (I).

8. The method as claimed in claim 6, in which, in variant (β), the first portion of the water is up to 4.0% of the mass of the total amount of water added in step (B).

9. The method as claimed in claim 1, in which step (B) is conducted at a temperature of 140° C. to 220° C.

10. The method as claimed in claim 1, in which the mass ratio of alcohol and water to the polyurethane product is in the range of 0.5 to 2.5, and in which the mass ratio of the water is 2.0% to 10% of the mass of the alcohol.

11. The process as claimed in claim 1, wherein the alcohol is selected from ethylene glycol, diethylene glycol, propylene glycol, dipropylene glycol, methyl glycol, triethylene glycol, glycerol, 2-methylpropane-1,3-diol or a mixture of two or more thereof.

12. The method as claimed in claim 1, in which the catalyst is selected from a carbonate, a hydrogencarbonate, an orthophosphate, a monohydrogenorthophosphate, a metaphosphate, a hydroxide, an organic amine, an organometallic compound or a mixture of two or more thereof.

13. The method as claimed in claim 1, in which the isocyanate component comprises an isocyanate selected from tolylene diisocyanate, the diisocyanates of the diphenylmethane series, pentane 1,5-diisocyanate, hexamethylene 1,6-diisocyanate, isophorone diisocyanate, xylylene diisocyanate, or a mixture of two or more thereof.

14. The method as claimed in claim 1, wherein the polyol component comprises a polyether polyol, a polyester polyol, a polyetherester polyol, a polyacrylate polyol and/or a polyethercarbonate polyol.

15. The method as claimed in claim 1, in which the organic solvent is selected from an aliphatic hydrocarbon, a cycloaliphatic hydrocarbon, an aromatic hydrocarbon or a mixture of two or more thereof.
